(19) United States
(12) Patent Application Publication
(10) Pub. No.: US 2013/0243684 A1
(43) Pub. Date: Sep. 19, 2013

(54) SYSTEMS, METHODS, AND APPARATUS FOR IODINE REMOVAL FROM HIGH VOLUME DILUTE BRINE

(71) Applicant: DRAKE WATER TECHNOLOGIES, INC., Helena, MT (US)

(72) Inventor: Ronald N. Drake, Helena, MT (US)

(73) Assignee: DRAKE WATER TECHNOLOGIES, INC., Helena, MT (US)

(21) Appl. No.: 13/786,653

(22) Filed: Mar. 6, 2013

Related U.S. Application Data
(60) Provisional application No. 61/610,003, filed on Mar. 13, 2012.

(51) Int. Cl. C01B 7/14

(52) U.S. Cl. CPC C01B 7/14
USPC 423/503; 422/187

(57) ABSTRACT

This disclosure describes systems, methods, and apparatus for recovery and purification of iodine from strong brine solutions having low concentrations of iodine. This can involve acidifying and oxidizing the strong brine solution to produce a solution of processed brine and elemental iodine. This solution can then be passed through a countercurrent sorber causing the elemental iodine to adsorb onto a solid sorbent such as GAC. The iodine-loaded sorbent is separated and regenerated, for instance via heating, producing regenerated sorbent and iodine vapor. The vapor can be condensed thus leaving solid elemental iodine.

### CLAIM OF PRIORITY UNDER 35 U.S.C. §119

The present application for patent claims priority to Provisional Application No. 61/610,003 entitled “SYSTEMS, METHODS, AND APPARATUS FOR IODINE REMOVAL FROM HIGH VOLUME DILUTE BRINE” filed Mar. 13, 2012, and assigned to the assignee hereof and hereby expressly incorporated by reference herein.

### FIELD OF THE INVENTION

The present disclosure relates generally to water treatment. In particular, but not by way of limitation, the present disclosure relates to systems, methods and apparatuses for removing iodine in brines with high total dissolved solids where iodine is at such low concentrations that traditional iodine removal techniques are not cost effective.

### BACKGROUND OF THE INVENTION

Several processes exist for recovering Iodine from natural brines and produced waters associated with oil and gas production. Existing iodine recovery processes cannot profitably treat large volumes of brine exhibiting low (<100 mg/L) concentrations of iodine in the presence of high (>30,000 ppm) total dissolved solids (TDS). New technology is needed to profitably recover iodine from high volume, but dilute brine resources.

The reference commercial process for iodine recovery from brines exhibiting iodine at concentrations of approximately 300 mg/L or greater, is the “blowing-out” process. This process removes hydrogen sulfide followed by bulk brine chlorination to oxidize iodide to elemental iodine. The elemental iodine is blown-out of the brine stream by air stripping, and the stripped brine stream is treated with lime to adjust pH for disposal by re-injection into the ground. Blown-out iodine is recovered in an adsorber charged with a mixture of hydroiodic and sulfuric acids. Sulfur dioxide is used to reduce adsorbed elemental iodine back to iodide. A slip-stream from the adsorber is again chlorinated to produce elemental iodine, which precipitates, is filtered, and melted under concentrated sulfuric acid to form ingots. For 90% recovery, the blowing-out process returns perhaps 30 mg/L iodine to the injection well. In addition, the blowing-out process requires chemical treatment (chlorination) and pH adjustment (acid addition) of the entire feed stream—an expensive proposition.

Four other processes or process variations also have commercial application to iodine recovery, but they each exhibit significant disadvantages. First, bulk brine can be chlorinated to oxidize iodide to iodine. The elemental iodine is adsorbed on granular activated carbon (GAC). When loaded, the GAC is back-flushed (cleaned) with potassium or sodium hydroxide to remove the adsorbed iodine. The concentrated caustic solution is neutralized with HCl and is re-chlorinated to produce a crude iodine precipitate that is approximately 90% iodine by weight. The crude iodine precipitate often benefit from further refining and thus the crude iodine precipitate does not command a high market value. Thus, this process produces a lower value product, has high chemical requirements, and is not particularly efficient.

Second, silver nitrate solution can be added to bulk brine to precipitate silver iodide, which is filtered out and treated with scrap iron to form metallic silver and a solution of ferrous iodide. The metallic silver is dissolved in nitric acid for recycle, and the solution is chlorinated to precipitate elemental iodine. Silver losses to the discharge brine can render this process unprofitable except where brines exhibit very high (say >500 mg/L) iodine concentrations.

Third, brine can be chlorinated to convert iodide to iodine. The iodine solution is then passed over bales of copper wire to precipitate insoluble cuprous iodide. Loaded bales are agitated and washed to recover the cuprous iodide, which is sold. This process is also relatively inefficient and produces a lower-value cuprous iodide product (cuprous iodide has few commercial uses).

Finally, bulk brine can be chlorinated and then treated with a strong base anion exchange resin to recover polyiodides in solution. Pregnant ion exchange resin (IXR) is regenerated with caustic and NaCl producing an iodine-rich solution that is then acidified and oxidized to precipitate elemental iodine. The elemental iodine solution is centrifuged and the solids are further refined with hot sulfuric acid, or by sublimation. This process does not work very well for brines that exhibit elevated concentrations of competing anions such as chloride or sulfate.

### SUMMARY OF THE DISCLOSURE

Exemplary embodiments of the present invention that are shown in the drawings are summarized below. These and other embodiments are more fully described in the Detailed Description section. It is to be understood, however, that there is no intention to limit the invention to the forms described in this Summary of the Invention or in the Detailed Description. One skilled in the art can recognize that there are numerous modifications, equivalents and alternative constructions that fall within the spirit and scope of the invention as expressed in the claims.

Some embodiments of the disclosure may be characterized as a method for recovering solid iodine from brine solutions. The method may comprise acidifying a strong brine solution, the strong brine solution having ionic iodine species in solution. The method may also comprise adding an oxidant to the strong brine solution, and forming elemental iodine from the strong brine solution. The method may further comprise sorbing the elemental iodine onto a regenerated solid sorbent to form an iodine-loaded solid sorbent. The method may yet further comprise heating the iodine-loaded solid sorbent to generate an iodine vapor and the regenerated sorbent. Yet further, the method may comprise condensing the iodine vapor to form the solid iodine.

Other embodiments of the disclosure may also be characterized as a method for recovering elemental iodine from aqueous solutions. The method may comprise reducing a pH of an aqueous solution containing iodide and iodate ions, and thereby raising an oxidation potential of the aqueous solution. The method may further comprise converting the iodide and iodate ions in the aqueous solution to elemental iodine. The method may yet further comprise sorbing the elemental iodine on sorbent via countercurrent adsorption to produce at least an iodine-loaded sorbent and a barren aqueous solution. Yet further, the method may comprise regenerating the iodine-loaded sorbent to form a regenerated sorbent and an iodine vapor. Additionally, the method may comprise converting the iodine vapor to elemental iodine.

Other embodiments of the disclosure can be characterized as a system for recovering and purifying iodine from brine solutions. The system may comprise a chemical reactor, a solids and liquids contactor, and a sorbent regeneration subsystem. The chemical reactor can receive a pregnant brine, including iodide and iodate, and producing a solution of elemental iodine and processed brine. The solids and liquids contactor can receive a regenerated sorbent and the solution of elemental iodine and processed brine and producing an iodine-loaded sorbent. The sorbent regeneration subsystem can receive thermal energy and the iodine-loaded sorbent and producing the regenerated sorbent and an iodine vapor.

### BRIEF DESCRIPTION OF THE DRAWINGS

Various objects and advantages and a more complete understanding of the present disclosure are apparent and more readily appreciated by referring to the following detailed description and to the appended claims when taken in conjunction with the accompanying drawings:

FIG. 1 illustrates one embodiment of an on-site iodine removal system;

FIG. 2 illustrates a more detailed view of the on-site iodine removal system illustrated in FIG. 2;

FIG. 3 illustrates an embodiment of the iodine countercurrent adsorption and sorbent thermal regeneration portions or operations illustrated in FIG. 2;

FIG. 4 illustrates one embodiment of an iodine removal from solution portion or operation; and

FIG. 5 illustrates a more detailed view of the on-site iodine removal system illustrated in FIG. 1.

### DETAILED DESCRIPTION

There appears to be a need for new technology to economically recover iodine (and perhaps bromine) from large volumes (e.g., 800,000 bbl/d) of relatively dilute (e.g., <100 mg/L) brines in the presence of high concentrations (e.g., >30,000 ppm) of competing ionic species. Although these iodine concentrations may be low, due to high volume, there is the potential for large volumes of recovered iodine recovery (e.g., 2,500 kg/d).

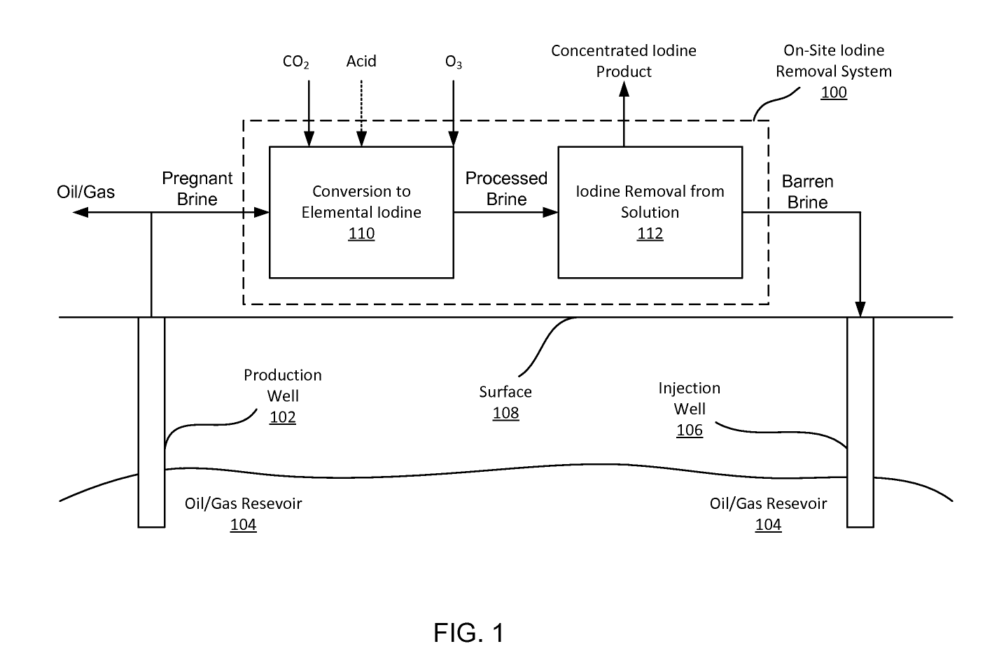

FIG. 1 illustrates one embodiment of an on-site iodine removal system 100. The on-site iodine removal system 100 (“the system”) is configured to receive a brine solution (e.g., a strong brine solution) produced from oil, gas, or oil and gas production and produce barren brine and a concentrated iodine product. The brine comes from production well 102 removing oil, gas, or both (“hydrocarbon products”) from an oil/gas reservoir 104, and in some embodiments may be a strong brine solution. The brine solution may also have a low concentration of iodine, for instance in the forms iodate, IO₃⁻, and iodide, I⁻. At or near the surface 108, the hydrocarbon products are separated from the brine and the brine is passed to the system 100. The system 100 includes a conversion to elemental iodine portion or process 110 in which ionic iodine (e.g., iodide, I⁻; iodate, IO₃⁻) is converted to elemental iodine, I₂, in brine. The conversion to elemental iodine portion or process 110 can reduce the pH of the brine via injection or contact with an acidifying agent such as carbon dioxide (e.g., from combustion), which can be used alone or can be supplemented with an acid (e.g., mineral or organic acid). At reduced pH, iodide and iodate in solution react to form elemental iodine and water. Portion or process 110 can then oxidize remaining reduced-pH iodide ions via mixing with ozone generated from the surrounding air to generate elemental iodine. The iodine is then removed from solution in an iodine removal from solution portion or process 112 to produce the concentrated iodine product. Without the iodine the brine is barren brine that can be pumped back under the surface 108, for instance via an injection well 106. The concentrated iodine product has uses in a number of manufacturing and service processes such as production of optical polarizing film for liquid crystal display screens (cell phones, notebooks, flat panel TV, etc.); catalyzing the production of acetic acid; purifying water; production of ethylenediammonium diiodide (a livestock nutritional supplement); and as a radiocontrast agent, to name just a few applications.

The system 100 achieves greater throughput than known systems for iodine removal, produces a more concentrated iodine product than known systems can, and does so via a mobile system 100 that can be towed or carried to purification sites and operated on-site without remote processing (e.g., remote regeneration of ion-exchange resins or granular activated carbons).

The following are some high-level functional and operational goals: (1) a simple, robust, transportable, automated, continuous, and universally applicable iodine recovery process; (2) achieve 10 mg/L iodine residual in treated brine—equivalent to 90% recovery from 100 mg/L feed and 50% recovery from 20 mg/L feed; (3) achieve >99% purity of elemental iodine product from field deployed units; (4) iodine recovery substantially independent of brine total ionic strength and speciation; (5) process should exhibit chemical procurement, and reagent transport, and handling costs that are less than 50% of those exhibited by competing technologies for equivalent total iodine recovery (in other words, minimize specific chemical usage and waste generation); (6) mobile or easily transportable process units for field deployment at sites where brine is produced; (7) robust process units for “oil-field” service at remote sites in harsh weather; (8) throughput greater than 25,000 bbl/d for one or more units working in parallel; (9) decreased energy/utility requirements; (10) decreased secondary waste generation; and (11) decreased operating labor and maintenance requirements.

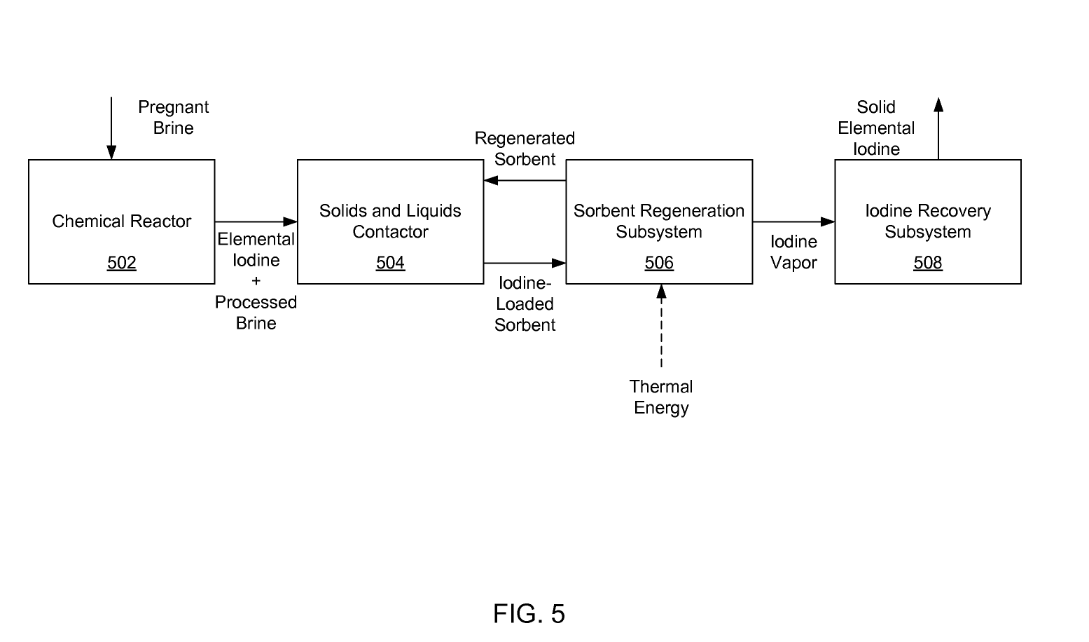

FIG. 5 illustrates a more detailed view of the on-site ion removal system illustrated in FIG. 1. Again, this system 500 is configured to recover and purify iodine from brine solutions, and especially strong brine solutions having low concentrations of iodine. The system 500 includes a chemical reactor 502, a solids and liquids contactor 504, and a sorbent regeneration subsystem 506. In some embodiments, the system 500 also includes an iodine recovery subsystem 508.

The chemical reactor is configured to receive a pregnant brine, including iodide, I⁻, and iodate, IO₃⁻. The chemical reactor is further configured to produce a solution of elemental iodine and processed brine. The solids and liquids contactor 504 is configured to receive a regenerated sorbent and the solution of elemental iodine and processed brine from the chemical reactor 502. It is configured to produce an iodine-loaded sorbent, which is then passed to and received by the sorbent regeneration subsystem 506. The sorbent regeneration subsystem may also receive thermal energy and use the thermal energy to regenerate the iodine-loaded sorbent, thus forming a regenerated sorbent and iodine vapor. The regenerated sorbent can be returned to the solids and liquids contactor and used to sorb further elemental iodine. The iodine vapor can be provided to and received by the iodine recovery subsystem 508 which is configured to transform the iodine vapor into solid elemental iodine (e.g., iodine crystals).

In some embodiments, the chemical reactor 502 is a continuous backmix reactor. In other embodiments, the chemical reactor 502 is a plug flow reactor. In yet further embodiments, the iodine recovery subsystem can include a vapor condenser. In other embodiments, the chemical reactor can include a pH reduction subsystem that is configured to contact an acidifying element (e.g., acid or CO₂ to name two examples) with the pregnant brine. The pH reduction subsystem can contact the acidifying element with the pregnant brine in order to reduce a pH of the pregnant brine. In one embodiment, the acidifying element can be at least partially sourced from products of the sorbent regeneration subsystem. For instance, where the sorbent regeneration subsystem 506 uses combustion to provide the thermal energy for regeneration of the sorbent, CO₂ off gases can be routed to the chemical reactor 502 and its pH reduction subsystem as the acidifying agent.

In a further embodiment, the chemical reactor 502 can include an oxidation subsystem that contacts the pregnant brine with an oxidant. In yet a further embodiment, the solids and liquids contactor 504 can be a continuous countercurrent contactor. In another embodiment, the sorbent regeneration subsystem 506 can include a screw conveyor submerged in a gas-fluidized bed of solid particles. The thermal energy for regenerating the sorbent can be provided to the gas-fluidized bed of solid particles via combustion of a fuel in the gas-fluidized bed.

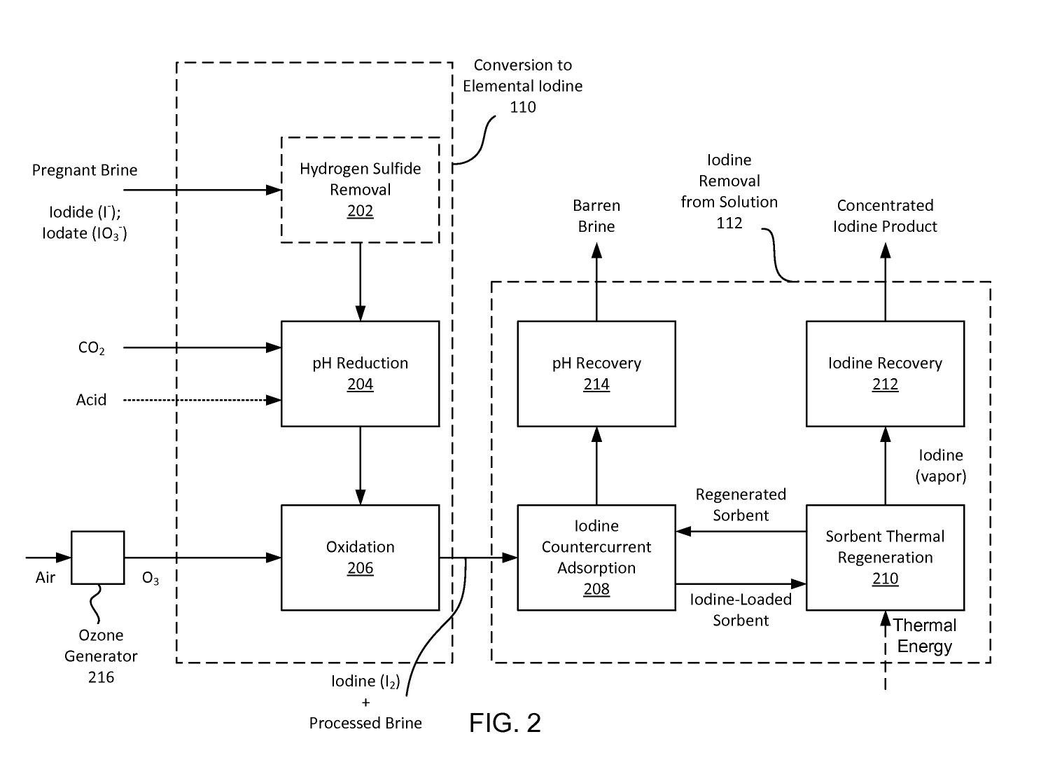

FIG. 2 illustrates another more detailed view of the on-site ion removal system illustrated in FIG. 1. The system comprises a conversion to elemental iodine portion or process 110 and an iodine removal from solution portion or process 112. The conversion to elemental iodine portion or process 110 takes in brine having iodide and/or iodate dissolved therein and outputs brine with elemental iodine dissolved or suspended therein. Elemental iodine is a non-polar molecule that is soluble in many organic solvents, but poorly soluble in water (e.g., 160 ppm at 0° C. and 950 ppm at 60° C.). Thus, for dilute brines the iodine is likely to be dissolved. However, where the brine is more concentrated, a portion of the elemental iodine may be suspended. The iodine removal from solution portion or process 112 receives the iodine in brine and removes the iodine from solution to produce the concentrated iodine product and barren brine or barren aqueous solution.

The conversion to elemental iodine 110 involves pH reduction or acidifying and oxidation/reduction (converting iodide and iodate to iodine). Typically acid (e.g., concentrated sulfuric acid) is used to reduce the pH and oxidation is performed via chlorination (mixing with chlorine gas). However, these chemicals are expensive, dangerous, and difficult to handle. Instead, the present disclosure lowers pH by contacting the brine with carbon dioxide via pH reduction 204. For example, the pH can be reduced from around 8.3 to around 4.0. As compared to acids, carbon dioxide is cheaper, safer, easier to handle, and easier to manufacture. In one embodiment, the carbon dioxide can even be obtained from a granular activated carbon regeneration process that will be discussed later. Treatment of brines containing substantial alkalinity (e.g., >50 ppm) or very low concentrations of iodide (e.g., <40 ppm), may require supplementary addition of acid to achieve sufficient reduction of brine pH (e.g., pH<3.0) as needed to effect desired conversion of iodide to iodine (e.g., >90%).

Chlorine, and its hazardous transportation of pressurized chlorine canisters, can be avoided by generating the oxidant onsite, for instance via ozone generated from the atmosphere in an ozone generator 216. The ozone generator 216 may use a corona discharge in air or any other ozone-generating method such as cold plasma generation using molecular oxygen or electrolysis of water. Addition of hydrogen peroxide or other oxidants also may be used to convert iodide to iodine in solution. The oxidant, such as ozone, is contacted to (or mixed with) the brine in oxidation 206 to produce elemental iodine dissolved or suspended in brine. This combination is hereinafter referred to as an iodine adsorber feed solution. Furthermore, ozone is a more efficient transformer of iodide to iodine (oxidation 206) than chlorine, and thus ozone consumption may be much lower than the chlorine consumption used in conventional processing. For instance, one mole of ozone produces one mole of iodine and one mole of oxygen. The one mole of oxygen in turn, produces two moles of iodine. Thus, each mole of ozone produces, directly or indirectly, three moles of iodine, as compared to a one-to-one conversion ratio for chlorine. Optionally, hydrogen sulfide can be removed from the brine (or pregnant liquor) before pH reduction 204 in an optional hydrogen sulfide removal 202.

The elemental iodine can then be removed from solution via “blowing-out” or granular activated carbon (GAC) adsorption. However, blowing-out may not be cost-effective with brines having less than around 300 mg/l of total iodine in solution. Ion-exchange is one alternative for these low-iodine-concentration brines, and does not require chlorination since it operates on ionic rather than elemental iodine. But, while ion-exchange can be effective for low total dissolved solids (TDS) applications, it is not very effective for high TDS applications since these tend to have high concentrations of competing anions such as chloride. The high chloride concentrations inhibit resin loading since the chloride tends to fill active resin exchange sites thus preventing substantial concentrations of iodate or iodide from being removed from solution. The result is that large amounts of resin are used to pull the iodine out of solution, and since the resin is chloride loaded, and chloride is the typical regenerant, very high concentrations of chloride regenerant are used to regenerate the ion-exchange resin. Thus, ion-exchange is not a preferred method for pulling iodate and iodide out of low-iodine-concentration, high TDS, solutions.

For brines having iodate and iodite concentrations below around 300 mg/l, and to avoid the pitfalls of ion-exchange adsorption, iodine can be removed from the brine by passing the stream through a sorbent bed where the iodine loads on the sorbent and can be recovered via sorbent regeneration. Thus, at least some of the sorbent in the sorbent that adsorbs iodine from the brine can be regenerated sorbent. In one embodiment, the sorbent is granular activated carbon (GAC), and can be used to remove elemental iodine from processed brine. Unlike ion-exchange resins, GAC is not a good adsorber of chloride ions, and thus the high concentration of chloride in the brine is not a problem. However, traditional GAC regeneration is problematic because the static GAC beds have to be taken offsite to be regenerated. Thus, the adsorption process is interrupted every time a GAC bed becomes fully loaded (e.g., when the brine-iodine stream “breaks through” a top of the static GAC bed). This not only decreases throughput, but also means that operators have less control over regeneration due to the periodic non-steady state conditions that are experienced when a new bed is brought online and when a loaded bed is pulled offline. Additionally, GAC regeneration typically requires costly sorbent-regenerating chemicals such as NaOH, SO₂, and H₂SO₄ as well as concentration and neutralization steps. Static bed GAC regeneration also involves matching the GAC loading rate to the GAC regeneration rate in order to maximize throughput.

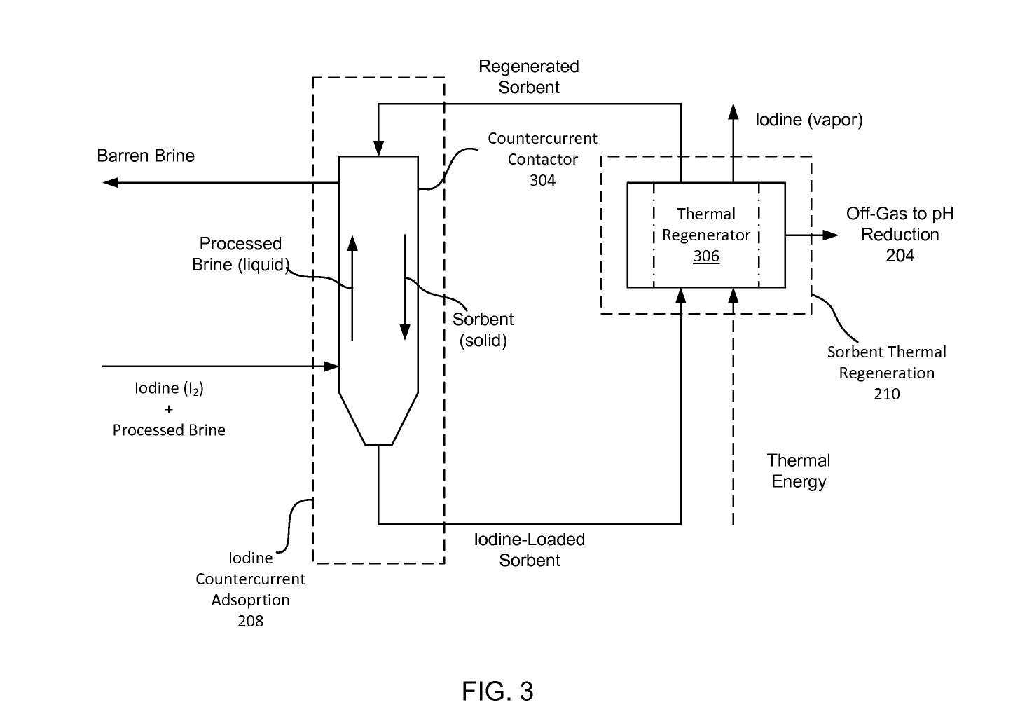

These challenges in the art are overcome by using a sorbent, such as GAC, to remove iodine from solution in the processed brine, by using iodine countercurrent adsorption 208 in tandem with thermal regeneration 210 rather than a traditional static bed separator and off-site regeneration of the sorbent. Iodine countercurrent adsorption 208 can be performed using a counter-current contactor as seen in FIG. 3. Countercurrent adsorption enhances sorbent loading as compared to static bed or cocurrent configurations.

The iodine-loaded sorbent can then pass to a sorbent thermal regeneration portion or operation 210 where thermal energy is added to the iodine-loaded sorbent to strip the iodine-loaded sorbent of iodine (e.g., via a thermal screw). The thermal energy can be imparted via steam, combustion gas, electricity, or hot oil, to name a few non-limiting examples.

The regenerated sorbent is then passed back to the iodine countercurrent adsorption 208 and the cycle restarts. The iodine is converted to a vapor in the sorbent thermal regeneration 210 and thereby separated from the sorbent. The iodine vapor is passed to an iodine recovery portion or operation 212 where the vapor is condensed or concentrated to produce a concentrated iodine product (e.g., via a direct contact condenser or an ejector venturi scrubber, to name two examples). At the same time, the brine separated in the iodine countercurrent adsorption 208, is passed through a pH recovery portion or operation 214 to produce barren brine, or a barren aqueous solution, that can be pumped back into the same or a different well. Barren brine is solution that has been substantially stripped of valuable components, and therefore there is little motivation for further recovery of those valuable species from the barren brine.

The pH recovery 214 removes dissolved carbon dioxide from solution. This can be accomplished by a variety and/or combination of means. In an embodiment, the solution is stripped with air using a stripping tower or spray pond. In another embodiment, the solution can be agitated in a mild or weak vacuum. In yet another embodiment, the solution can be heated to drive off dissolved gases including carbon dioxide. In a further embodiment, the solution is contacted with or run over a carbonate mineral. In yet a further embodiment, the solution can be reacted with a base such as lime, soda ash, or caustic.

The iodine removal from solution operation or process 112 involves a continuous-loop cycle that does not require stoppage for regeneration. As such, the iodine removal from solution portion or process 112 has various advantages over the art. For instance, the portion or process 112 is mobile and has greater throughput than systems and methods in the art. The portion or process 112 is also less complicated and uses less sorbent than systems or method in the art. The portion or process 112 further benefits from steady-state operation.

FIG. 3 illustrates an embodiment of the iodine countercurrent adsorption 208 and sorbent thermal regeneration 210 portions of the iodine removal from solution 112 of FIGS. 1 and 2. The processed brine having elemental iodine in solution therein is received from the conversion to elemental iodine 110 in a countercurrent contactor 304. The countercurrent contactor 304 countercurrently mixes the processed brine and elemental iodine with a sorbent, such as GAC, to remove the iodine from solution. The countercurrent contactor 304 can be a continuous moving bed sorbent contactor, and in some cases the sorbent can be GAC. Other non-limiting examples of the countercurrent contactor 304 include fluidized beds, substantially packed beds, expanded beds, and incipiently fluidized beds. Barren brine, or a barren aqueous solution, and iodine-loaded sorbent exit the countercurrent contactor 304.

The barren brine can be degassed to recover the pH and then re-injected into the ground or disposed of in some other fashion. The sorbent can be considered loaded with iodine and exits the countercurrent contactor 304 to be regenerated in thermal regenerator 306 (e.g., a thermal screw). The thermal regenerator 306 receives thermal energy (e.g., from steam) that is transferred to the iodine-loaded sorbent as the iodine-loaded sorbent is transported through the thermal regenerator 306. The iodine is thermally released from the iodine-loaded sorbent as a vapor and exits the thermal regenerator 306 to be condensed or otherwise processed. The regenerated (or barren) sorbent is returned to the countercurrent contactor 304 to adsorb further iodine.

To increase the number of iodine molecules that each activation site on the sorbent particles see, the processed brine and elemental iodine is contacted with the sorbent in a countercurrent fashion in the countercurrent contactor 304. In other words, the processed brine and elemental iodine travels in a direction opposite to the sorbent. In the illustrated embodiment, the processed brine and elemental iodine travels upward through a gravity-drawn stream of sorbent. The sorbent can be a liquid-phase carbon or other liquid-phase sorbent meaning that it is configured to adsorb in a liquid medium such as the processed brine and elemental iodine.

The thermal regenerator 306 is used for sorbent regeneration and enables a continuous cycle between the countercurrent contactor 304 and the sorbent thermal regenerator 306. Thus, the thermal regenerator 306 regenerates sorbent as the sorbent passes through the thermal regenerator 306, and this regeneration is performed without interruption of the cycle as is often required in the art. This has significant advantages over static bed regeneration including use of less sorbent, avoidance of non-steady state regimes and hazardous regenerants, and greater throughput. Fluid can be moved through the thermal regenerator via a pump, screw, or other fluid moving mechanism such as an auger.

Thermal energy, is transferred to the sorbent inside the thermal regenerator 306 to vaporize the iodine and release it from the sorbent (e.g., from the sorbent pores, and surface). Thermal energy can be provided combustion gas, electrical power, hot oil, or steam, to name a few non-limiting examples. The iodine vapor can leave the thermal regenerator 306 via a pressure gradient between the inside of the thermal generator 306 and an outlet of the thermal regenerator 306. While the iodine vapor is illustrated as exiting the thermal regenerator 306 in an upward direction, and the thermal energy is illustrated as entering the thermal regenerator 306 in an upward direction, these are not to be taken as limiting. In certain embodiments, the thermal energy can enter and the iodine can exit from the top, bottom, sides, or two or more directions relative to the thermal regenerator 306.

The thermal regenerator 306 can operate at any temperature sufficient to regenerate the sorbent (e.g., >250° C. for GAC), however, in one embodiment, the thermal regenerator 306 operates at a temperature higher than needed to regenerate 100% of the sorbent (e.g., the boiling point of elemental iodine is about 185° C.). In other words, a temperature buffer can be generated in the thermal regenerator 306 such that even if there are thermal fluctuations due to the amount or temperature of sorbent entering the thermal regenerator 306, the temperature will still remain high enough to regenerate all sorbent passing through the thermal regenerator 306. The temperature buffer is a temperature gap above the temperature needed during steady-state to regenerate all sorbent passing through the thermal regenerator 306. For instance, the thermal regenerator 306 can be operated in on embodiment, at an average internal temperature that is 10-15° C. above an elemental iodine vaporization temperature (e.g., an average internal temperature of at least 194.3° C.).

The thermal energy can be imparted to the sorbent via the thermal regenerator 306 walls and/or via thermally conductive components within the thermal regenerator 306. For instance, where there is an auger rotating within a thermal screw, both the walls and the auger can be heated by the thermal energy and can transfer this thermal energy to the sorbent via conduction and convection. In addition to, or alternatively, a gas in the thermal regenerator 306 can transfer the thermal energy to the sorbent. For instance, steam can enter the thermal regenerator 306 and transfer the thermal energy to the sorbent upon contacting the sorbent in the thermal regenerator 306.

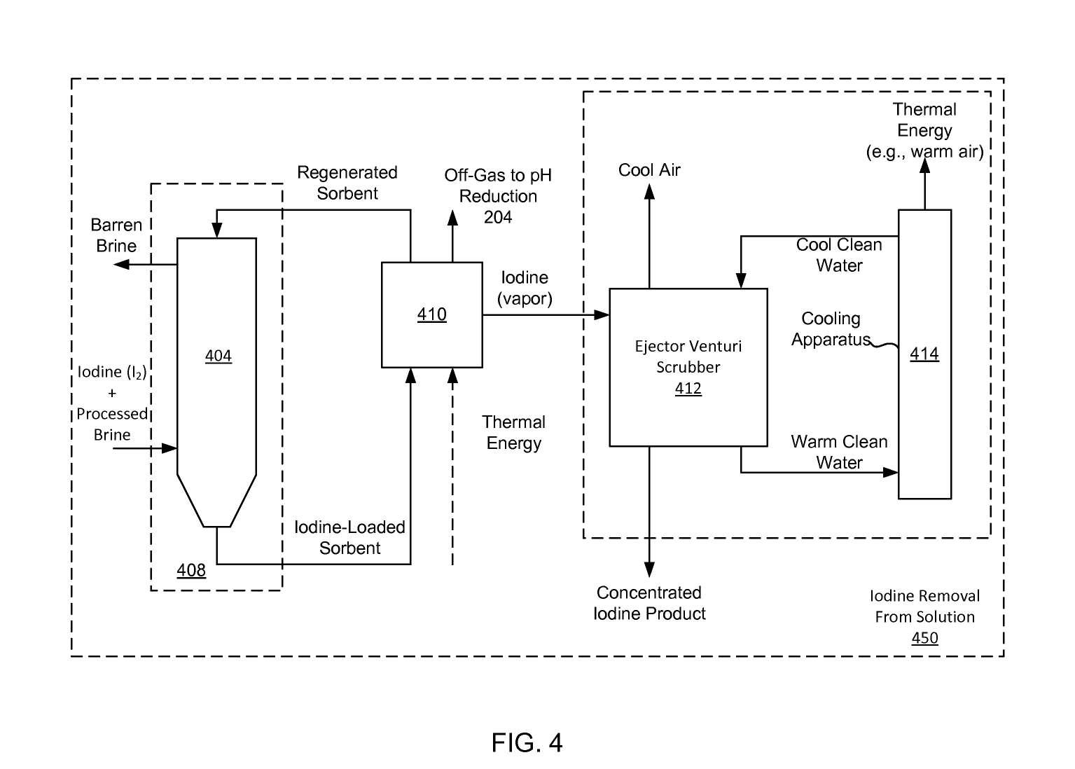

The iodine gas that exits the thermal regenerator 306 can be condensed and converted to solid iodine in a cold trap, spray tower, or ejector venturi scrubber, to name just three examples. Transformation of the iodine gas to a solid will be discussed further with reference to FIG. 4.

The thermal regenerator 306 can also generate off-gas (e.g., CO₂), for instance as the result of the thermal energy being contacted with the sorbent. In a non-illustrated embodiment, this off-gas can be passed back to the conversion to elemental iodine portion or operation 110 and used to reduce the pH of the brine in the pH reduction 204 (see CO₂ input to 204 in FIG. 2). In this fashion, the brine's pH can be reduced via on-site generated off-gas from the thermal regenerator 306 thus avoiding transportation and remote generation of pH-reducing chemicals.

While static bed sorbent systems in the art typically include various sensors and analytics to monitor the sensor readings, the countercurrent contactor 304 in series with the thermal regenerator 306 operates with very little monitoring. One of the few possible monitorings, is a monitoring of concentrations of iodine entering and exiting the countercurrent contactor 304. These two values indicate what percentage of iodine is being removed from the iodine adsorber feed solution (adsorber feed), since iodine removal depends on the ratio of sorbent to iodine in the contactor 304. Based on the percentage of iodine being removed, the fluid flow rate in the iodine removal from solution 112 can be adjusted. For instance, if it is desired to remove a greater percentage of iodine, then the rate of processed brine and elemental iodine entering the countercurrent contactor 304 can be decreased and/or the rate of sorbent passing through the thermal regenerator 306 can be increased (e.g., by increasing a rotation rate of an auger of the thermal regenerator 306). Increasing the ratio of sorbent to processed brine and elemental iodine in the countercurrent contactor 304 can increase the percentage of iodine removed. Similarly, less iodine can be removed by decreasing the ratio of sorbent to processed brine and elemental iodine in the countercurrent contactor 304. In other words, the ratio of sorbent to processed brine and elemental iodine fed to the countercurrent contactor 304 can be adjusted by changing the sorbent feed rate, changing the feed rate of processed brine and elemental iodine, or changing both feed rates.

As described above, the rate of fluid flow through the iodine removal from solution 112 is controlled by a combination of the speed of the GAC passing through the thermal regenerator 306 and the rate of processed brine entering the countercurrent contactor 304. Most of the processed brine travels up the countercurrent contactor 304 and exits the contactor 304. Some of the processed brine travels down and out of the countercurrent contactor 304 and enters the thermal regenerator 306. Since some processed brine exits with the GAC leaving the bottom of the countercurrent contactor 304, both GAC and iodine adsorber feed solution may pass through the thermal regenerator 306.

GAC does not have to continuously travel forward within the thermal regenerator 306. It is possible that GAC can move in a circular pattern such that GAC may move backwards as well as forwards within the thermal regenerator 306 as long as the GAC enters the thermal regenerator 306 at the same rate that it exits the thermal regenerator 306 (it may also be necessary to account for a difference in entry and exit fluid velocity resulting from the iodine gas exiting the thermal regenerator 306 before the GAC exits).

While the countercurrent contactor 304 has been described in terms of GAC, other sorbents are also envisioned. For instance, activated alumina sorbent or molecular sieves can be used such as an alumina-silicate molecular sieve.

FIG. 4 illustrates one embodiment of an iodine removal from solution portion or operation 112. Iodine adsorber feed solution enters a countercurrent contactor 404, interacts with a sorbent moving countercurrent to the processed brine solution, the sorbent removes some or all iodine from the iodine adsorber feed solution, and then the brine exits as barren brine—a solution having a lower concentration of iodine than the concentration of iodine in the processed brine feed solution. The sorbent, now loaded with iodine, exits the countercurrent contactor 404 and enters a thermal regenerator 406. The thermal regenerator 406 uses an input of thermal energy (e.g., steam, electrical, combustion) to regenerate the sorbent. In other words, some or all of the iodine loaded on the sorbent is separated from the sorbent (e.g., via vaporization). The separated iodine exits the thermal regenerator 406 as a gas and is passed to an ejector venturi scrubber 408 which contacts the iodine gas with a spray of cool clean water which condenses the gas. The ejector venturi scrubber 408 can be operated at a temperature below the melting point of iodine (˜113.5° C., which is also above the boiling point of water at the same pressure), which causes the iodine to precipitate out as iodine crystals. The ejector venturi scrubber 408 also produces warm iodine-saturated water that is passed to a cooling apparatus 410 and cool air is exhausted from the ejector venturi scrubber 408. Alternatively, other cooling systems and apparatus can be used. For instance, the iodine vapor can be contacted with a cold surface, such as at a temperature below the melting point of iodine, thus initiating precipitation of solid iodine from the iodine vapor.

The warm iodine-saturated water may be saturated with dissolved iodine and have some suspended iodine crystals. The cooling apparatus 410 removes thermal energy from the warm water and passes cool water back to the ejector venturi scrubber 408 where the cool water is contacted with more gaseous iodine from the thermal regenerator 406. The thermal regenerator 406, meanwhile, produces regenerated sorbent that is circulated back into the countercurrent contactor 404. The thermal regenerator 406 also can produce an off-gas that can be passed back to the pH reduction 204 described with reference to FIG. 2.

In conclusion, the present disclosure provides, among other things, a method, system, and apparatus that enables safe and inexpensive isolation of elemental iodine from brine containing iodate and iodide along with countercurrent contact adsorption of the elemental iodine out of the brine solution and thermal regeneration of the sorbent in a continuous loop adsorber-regenerator system. Those skilled in the art can readily recognize that numerous variations and substitutions may be made in the disclosure, its use, and its configuration to achieve substantially the same results as achieved by the embodiments described herein. Accordingly, there is no intention to limit the disclosure to the disclosed exemplary forms. Many variations, modifications, and alternative constructions fall within the scope and spirit of the this disclosure.

### Chemical Equations Describing Iodide and Iodate Conversion to Elemental Iodine

Positive voltages indicate favorable reactions.
Reaction of iodate and iodide in acidic solution:

IO₃⁻+5I⁻+6H⁺ [symbol] 3I₂(s)+3H₂O+0.66 V

Oxidation of iodide to iodine by ozone in acidic solution:

O₃(g)+2H⁺+2I⁻ [symbol] I₂(s)+O₂+H₂O+1.535 V

Oxidation of iodide to iodine by molecular oxygen in acidic solution:

O₂(g)+4H⁺+4I⁻ [symbol] 2I₂(s)+2H₂O+0.69 V

Oxidation of iodide to iodine by chlorine:

Cl₂(g)+2I⁻ [symbol] I₂(s)+2Cl⁻+0.82 V

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method for recovering solid iodine from brine solutions, said method comprising:
acidifying a strong brine solution, the strong brine solution having ionic iodine species in solution;
adding an oxidant to the strong brine solution;
forming elemental iodine from the strong brine solution;
sorbing the elemental iodine onto a regenerated solid sorbent to form an iodine-loaded solid sorbent;
heating the iodine-loaded solid sorbent to generate an iodine vapor and the regenerated sorbent; and
condensing the iodine vapor to form the solid iodine.

2. The method of claim 1, wherein the elemental iodine is sorbed onto the solid sorbent via counter current contact with the solid sorbent.

3. The method of claim 1, wherein the regenerated sorbent is continuously cycled through the sorbing and heating steps.

4. The method of claim 1, wherein the condensing involves cooling the iodine vapor to form the solid iodine.

5. The method of claim 4, wherein the iodine vapor is condensed by direct contact with cool water.

6. The method of claim 4, wherein the iodine vapor is condensed by contact with a cold surface.

7. The method of claim 1, wherein carbon dioxide is added to the strong brine solution in the acidifying.

8. The method of claim 7, wherein acid is added to the strong brine solution in the acidifying.

9. The method of claim 1, wherein the oxidant is ozone.

10. A method for recovering elemental iodine from aqueous solutions, said method comprising:
reducing a pH of an aqueous solution containing iodide and iodate ions, and thereby raising an oxidation potential of the aqueous solution;
converting the iodide and iodate ions in the aqueous solution to elemental iodine;
sorbing the elemental iodine on sorbent via countercurrent adsorption to produce at least an iodine-loaded sorbent and a barren aqueous solution;
regenerating the iodine-loaded sorbent to form a regenerated sorbent and an iodine vapor; and
converting the iodine vapor to elemental iodine.

11. The method of claim 10, wherein the first converting involves oxidation.

12. The method of claim 10, wherein the sorbent is a solid sorbent.

13. The method of claim 12, wherein the solid sorbent is granular activated carbon.

14. The method of claim 10, wherein the sorbent at least partially comprises the regenerated sorbent.

15. A system for recovering and purifying iodine from brine solutions, said system comprising:
a chemical reactor receiving a pregnant brine, including iodide and iodate, and producing a solution of elemental iodine and processed brine;
a solids and liquids contactor receiving a regenerated sorbent and the solution of elemental iodine and processed brine and producing an iodine-loaded sorbent; and
a sorbent regeneration subsystem receiving thermal energy and the iodine-loaded sorbent and producing the regenerated sorbent and an iodine vapor.

16. The system of claim 15, wherein the chemical reactor is a continuous backmix reactor.

17. The system of claim 15, wherein the chemical reactor is a plug flow reactor.

18. The system of claim 15, further comprising an iodine recovery subsystem that receives the iodine vapor and produces solid elemental iodine.

19. The system of claim 18, wherein the iodine recovery subsystem includes a vapor condenser.

20. The system of claim 19, wherein the vapor condenser includes an ejector venturi scrubber.

21. The system of claim 15, wherein the chemical reactor includes a pH reduction subsystem that contacts an acidifying element with the pregnant brine.

22. The system of claim 21, wherein the pH reduction subsystem contacts CO₂ with the pregnant brine, and wherein the CO₂ is a product of the sorbent regeneration subsystem.

23. The system of claim 15, wherein the chemical reactor includes an oxidation subsystem that contacts the pregnant brine with an oxidant.

24. The system of claim 15, wherein the solids and liquid contactor is a continuous countercurrent contactor.

25. The system of claim 24, wherein the regenerated sorbent moves downward and the solution of elemental iodine and processed brine moves upward in the continuous countercurrent contactor.

26. The system of claim 15, wherein the sorbent regeneration subsystem includes a screw conveyor submerged in a gas-fluidized bed of solid particles.

27. The system of claim 26, wherein the thermal energy is provided to the gas-fluidized bed of solid particles via combustion of fuel in the gas-fluidized bed.

28. The system of claim 15, wherein the brine solution is a strong brine solution.

29. The system of claim 28, wherein the strong brine solution contains low concentrations of iodine.
